(19) United States
(12) Patent Application Publication
(10) Pub. No.: US 2019/0196217 A1
(43) Pub. Date: Jun. 27, 2019

(54) EYEGLASS RETAINER

(71) Applicants: Yusuke OTOMO, Tokyo (JP); Shiho OZAWA, Tokyo (JP)

(72) Inventors: Yusuke OTOMO, Tokyo (JP); Shiho OZAWA, Tokyo (JP)

(21) Appl. No.: 16/226,637

(22) Filed: Dec. 20, 2018

(30) Foreign Application Priority Data
Dec. 25, 2017 (JP) 2017-247408
Jul. 10, 2018 (JP) 2018-130581

(51) Int. Cl. G02C 3/00

(52) U.S. Cl. CPC G02C 3/003; G02C 5/143; G02C 3/006

(57) ABSTRACT

The eyeglass retainer comprises a pair of elastic tubes, to each of those which each of the temples of eyeglasses is forcibly inserted, a pair of wire members each connected to the corresponding elastic tube, and a pair of piece members each fixed to the corresponding end of the wire member; wherein each of the wire members is slidably inserted through the corresponding piece member at the middle position of the wire member with intervention of given sliding frictional force, the tubes made of elastic synthetic resin, through those which the wire members are slidably inserted with intervention of given frictional force, are embedded inside the piece members, respectively, and the wire members and the tubes made of elastic synthetic resin are interactively configured such that the tensile force to be generated when pulling the pair of piece members adapted to slide against the wire members.

### CROSS-REFERENCES TO RELATED APPLICATIONS

This patent specification is based on Japanese patent application, No. 2017-247408 filed on Dec. 25, 2017 and No. 2018-130581 filed on Jul. 10, 2018 in the Japan Patent Office, the entire contents of which are incorporated by reference herein.

### BACKGROUND OF THE INVENTION

### 1. Field of the Invention

This invention relates to eyeglass retainers. More specifically, this invention relates to eyeglass retainers adapted to prevent eyeglasses from falling down from the face of the eyeglass wearer.

### 2. Description of Related Art

An eyeglass frame is normally provided with two elongated members each of those which extends from one of the outer ends of the eyeglass frame to the wearer's ear, and the curved leading end (known as “temple”) of the eyeglasses is adapted to be inserted to a position between the basal part of the wearer's ear and the wearer's head so that the eyeglasses is held by said elongated members. With such a configuration, however, the eyeglasses would be fallen down from the wearer's face when the wearer moved the own head violently, that might induce an unsafe accident.

For the sake of preventing such accident from being occurred, a means to connect a pair of temples of eyeglasses at the back side of the wearer's head with either strings or wire members to thereby prevent the eyeglasses from being fallen down is conventionally known. As an example of eyeglass retainer with the similar configuration, the one disclosed in Japanese Utility Model No. 3199257 Gazette is known. This eyeglass retainer is such configured that both temples of eyeglasses are connected with a pair of wire members and the lengths of said wire members can be easily adjusted when they are arranged behind the wearer's head. However, this eyeglass retainer has drawback in respect of function of the friction-imparting means though it is configured that a slip member (a piece member) is intervened between said pair of wire members so that the wire members can slide against the piece members with certain degree of sliding frictional force.

As the other example, an articulating eyeglass retainer system is disclosed in U.S. Pat. No. 8,523,350 B2. In this example, elastic tubes so adapted that the end portions of the temples of eyeglasses are inserted thereto are interchangeable with respect to cables adapted to be worn behind the wearer's head. However, this system has difficulty in the handleability for easy and speedy fitting and detachment of elastic tubes against the cables, since strong force is required for forcibly fitting a hard ball member to a hard socket and for manually operating the forced removal of said fitting using external force. Moreover, no disclosure was made concerning the means to adjust the length of the cables in this patent.

### BRIEF SUMMARY OF THE INVENTION

It is an object of this invention to provide an eyeglass retainer which is lightweight, does not give a sense of discomfort to the wearer when wearing, and can firmly retain the eyeglasses to the wearer's face even though it receives intense exercise and shock.

It is another object of this invention to provide an eyeglass retainer, wherein the lengths of two wire members to be worn behind the wearer's head can be adjusted by sliding the wire members under intervention of appropriate frictional force to thereby easily fit the retainer to the size and shape of the wearer's head.

It is still another object of this invention to provide an eyeglass retainer, wherein the elastic tubes to each of those which the temple of the eyeglasses is inserted can be easily connected or disconnected with the wire member so that only the elastic tube can be interchanged with the other elastic tube of the different size to thereby make the eyeglass retainer usable for the other types of eyeglasses with various fashions.

The eyeglass retainer of this invention comprises: a pair of elastic tubes, to each of those which the end of temple is forcibly inserted,

a pair of wire members, the basal portion of each of those which is connected to the elastic tube, and

a pair of piece members fixed to the tip ends of said wire members, respectively,

wherein one of the pair of wire members is slidably inserted to the piece member having been stuck to the tip end of the other wire member under intervention of given frictional force,

said other wire member is slidably inserted to the piece member having been stuck to the tip end of said one of the pair of wire members under intervention of predetermined frictional force,

inside each of the piece members, a tube made of elastic synthetic resin adapted to be slidably inserted with the wire member under intervention of given frictional force is embedded,

the wire members and the tubes made of elastic synthetic resin are configured such that tensile force to be generated when the pair of piece members sliding against the wire members are pulled to such direction that they are away from each other at a speed of 100 mm/min. is maintained at a range of from 0.2 to 3.5 N (Newton), and

a first hard member is connected to the basal portion of each wire member, and second hard member is stuck to the end of each elastic tube, screw portions for screw-connecting the first and second hard members are respectively formed to both hard members, and the elastic tubes adapted to be inserted with the wire members are replaceable with the other type of elastic tube by unscrewing the screw portions.

For the eyeglass retainer of the type described above, it is required that the wire members adapted to be worn behind the wearer's head can be adjusted under intervention of appropriate frictional force. If said frictional force is too weak, the wire members move down, whereas said frictional force is too strong, the adjustment of the lengths of the wire members will not be applicable. With this invention, however, proper frictional force can be attained easily by virtue of the frictional force imparting means (an elastic tube) built in the interior of the piece member.

### BRIEF DESCRIPTION OF THE DRAWINGS

FIG. 1 is a side view showing the entire eyeglass retainer according to Example 1 of this invention.

FIG. 2 is a view showing the state of the eyeglasses being fixed by applying the eyeglass retainer according to Example 1 of this invention behind the wearer's head.

FIG. 3 is a longitudinal cross section of the connecting portion of the elastic tube and the wire member according to Example 1 of this invention showing the structure thereof.

FIG. 4A is a plan view of the divided plane of the piece member of the eyeglass retainer according to this invention and FIG. 4B is a cross section thereof cut along the line A-A in FIG. 4A.

FIG. 5A is a transverse cross section showing the state of placement of the wire members and the elastic tubes along the line A-A shown in FIG. 4A and FIG. 5B is a cross section cut along the line B-B shown in FIG. 5A.

FIG. 6A is a longitudinal cross section of the end of the wire member adapted to be connected to the elastic tube of the eyeglass retainer according to Example 2 and FIG. 6B is a longitudinal cross section of the elastic tube adapted to be connected to the end of the elastic tube.

FIG. 7 is a longitudinal cross section showing the shape of the elastic tube of the other size to be applied in Example 2 of this invention.

FIG. 8 is a side view showing the connecting portion of the elastic tube and the wire member used in the eyeglass retainer according to Example 2 of this invention.

### DETAILED DESCRIPTION OF THE INVENTION

Now, various examples of this invention will be explained with referring to the appended drawings.

### EXAMPLE 1

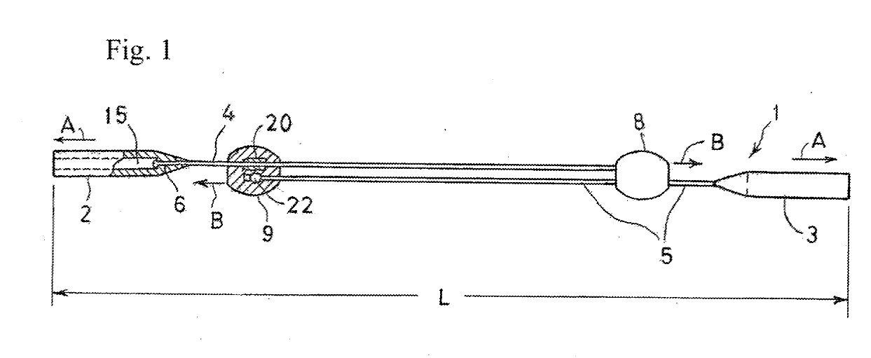

In Example 1 shown in FIG. 1, the eyeglass retainer 1 is consisted of a pair of elastic tubes 2, 3, a pair of wire members 4, 5 respectively extending from said elastic tubes 2, 3, and a pair of piece members 9, 8 into those which the wire members 4, 5 are respectively inserted. When it is used, the ends of the temples of the eyeglasses are forcibly inserted into the openings locating at the ends of the elastic tubes 2, 3, respectively.

The piece member 8 at the right side is fixed to the tip end of the wire member 4 at the left side extending from the elastic tube 2 at the left side, and the other piece member 9 at the left side is fixed to the tip end of the other wire member 5 at the right side extending from the other elastic tube 3 at the right side. The wire member 4 is slidably moving through the piece member 9 under intervention of certain frictional force and is fixed to the piece member 8. Similarly, the other wire member 5 is slidably moving through the piece member 8 under intervention of certain frictional force and is fixed to the piece member 9.

The entire length L of the eyeglass retainer 1 gets longer by manually pulling the elastic tubes 2, 3 locating both sides to the directions (the directions indicated by arrows A in FIG. 1) so that they move away from each other, and the entire length of the eyeglass retainer 1 gets shorter by manually pulling the pair of piece members 8, 9 to the directions (the directions indicated by arrows B in FIG. 1) so that they move away from each other. In this way, the length of the eyeglass retainer 1 can be adjusted.

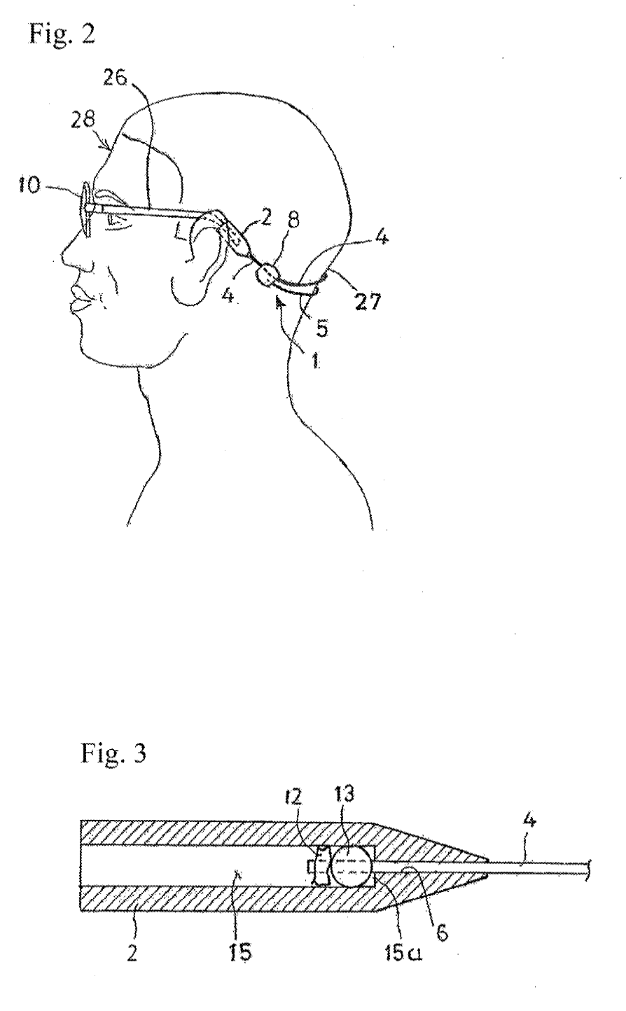

FIG. 2 is a view showing the state of fixing of the eyeglasses 10 to a position behind the wearer's head by means of the eyeglass retainer 1 according to this invention. For the fixing, the tip portions of both temples 26 each extending from the frame of the eyeglasses 10 are forcibly inserted into the elastic tubes 2, 3 (FIG. 2 shows the fixed state at just one side), respectively, and the wire members 4, 5 of the eyeglass retainer 1 are then worn over the back of the head 27 of the wearer 28. By adjusting the lengths of the wire members in the manner described above to contact the wire members 4, 5 tightly to the back of head 27 of the wearer, the eyeglasses 10 are held to the face of the wearer 28.

As shown in FIG. 3, in the elastic tube 2 according to Example 1, a hole 15 into which the temple is forcibly inserted and a narrow hole 6 into which the wire member 4 is inserted are built in communication with each other, and the uneven level portion 15a is formed between the hole 15 and the narrow hole 6. The end of the wire member 4 is inserted through a round member 13 inside the hole 15, and a stopper 12 made of a metal piece or the like is fixed to the end of the wire member 4 by means of caulking fixation. Owing to that the round member 13 is blocked by the uneven level portion 15a, and the stopper 12 exerts function of preventing the round member 13 from being slipped out, the wire member 4 is fixed to the elastic tube 2.

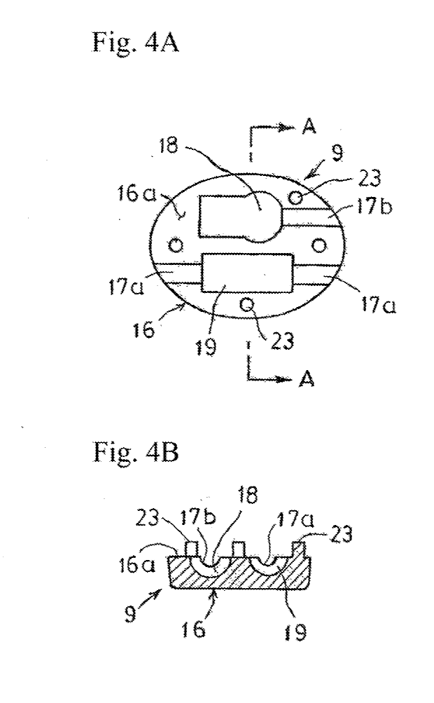

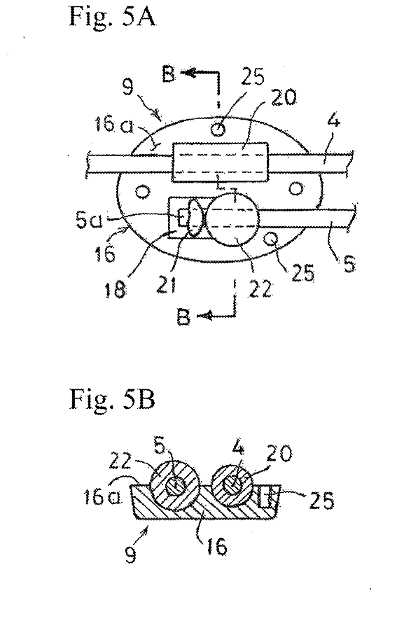

Now, the mechanism of imparting frictional force given to the piece member by the wire member that slidably moves through the piece member will be explained together with the structure of the piece member. Although only the piece member 9, into which the wire member 4 moves through, will be explained in the following with referring to FIGS. 4A, 4B, 5A and FIG. 5B, the same explanation is applicable to the other piece member 8 (FIG. 1), into which the other wire member 5 moves through. The piece member 9 produced by means of resin molding, etc. is formed in two divided parts being in substantially the same shape along the elongating direction of the wire member 4 that moves therethrough. On the divided half 16 of the piece member, an insertion groove 17a adapted to insert the wire member 4 to the divided plane 16a and a large concave groove 19 having semi-cylindrical shape transverse cross section adapted to receive the elastic tube 20 (FIGS. 5A and 5B) in the middle position of the insertion groove 17a are formed.

Further, on the divided plane 16a of the piece member 16, a wire member receiving groove 17b for receiving and fixing the end of the wire member 5 in parallel to the insertion groove 17a and a concave portion 18 for receiving the round member 22 (FIGS. 5A and 5B) adapted to be placed to the end of the wire member 5 are formed. As shown in FIGS. 5A and 5B, a stopper 21 for preventing the round member 22 from being slipped out is fixed to the end 5a of the wire member 5 by means of caulking fixation.

On the divided plane 16a (FIG. 4A) of one of the two divided piece member halves, a small protrusion 23 is formed, and a small hole 25 is formed on a position on the divided plane 16a (FIG. 5A) of the other piece member so that the position of the small hole 25 corresponds to the small protrusion 23. The tube 20 made of elastic synthetic resin inserted into the wire member 4 is received in the large concave groove 19 on the divided plane, and the round member 22 to which the end 5a of the other wire member 5 having been inserted is received in the concave potion 18 on the divided plane. In this state, by fitting the small protrusions 23 on divided planes to the small holes 25, respectively and the contacting both of two piece member halves 16 on the divided plane 16a, the tube 20 made of elastic synthetic resin to which the wire member 4 having been inserted is embedded in the piece member 9, and the end of the other wire member 5 is fixed to the piece member 9 together with the round member 22 and the stopper 21.

The sliding frictional force generated when the piece member 9 slides toward the wire member 4 is caused by the fitting of the tube 20 made of an elastic synthetic resin and the wire member 4. The sliding frictional force at the other wire member 5 and the piece member 8 is also generated by the fitting thereof.

Said sliding frictional force generated between the wire members and the tube made of an elastic synthetic resin is a very critical element in the actual use of the eyeglass retainer according to this invention. If said sliding frictional force is too loose, the pair of wire members extrude from the piece members during the use, which may cause the eyeglasses to fall off the wearer's head. Conversely, if said force is too strong, manual handling of the length adjustment of the wire members of the eyeglass retainer will be difficult.

For the sake of generating the appropriate frictional force at between the piece members and the wire members, when a tube member made of silicon rubber is used for the tube 20 made of an elastic synthetic resin and a wire member made of stainless steel covered with resin is used for the wire member 4, the inner diameter of the tube 20 and the outer diameter of the wire member 4 are made substantially the same. Alternatively, the inner diameter of the tube 20 may be made so that it gets slightly less than the outer diameter of the wire member 4. As a specific example, when the outer diameter of the wire member 4 covered with resin is set to 1.3 mm, the inner diameter of the tube 20 becomes approximately 1.3 mm. Otherwise, the inner diameter of the tube 20 may be made smaller the former. By properly selecting the lengths of the inner and outer diameters, appropriate frictional force is given to the tube and the wire member, whereby the eyeglasses may be surely held to the wearer's face and head without causing the looseness of the wire members against the piece members, when the temples of the eyeglasses are forcibly inserted into the elastic tubes of the eyeglass retainer and the wire members are worn behind the wearer's head. Besides, since generation of the sliding frictional force at between the wire member and the tube is related to various factors other than the outer and inner diameters of both members, it will thus be discussed hereinafter.

In a specific example, wherein a plurality of eyeglass retainers of which sliding frictional force at between the piece members and the wire members made of stainless steel having been covered with resin is thought to be the best were selected, and the frictional force generated at between said both members (the piece member and the wire member) was examined for the respective eyeglass retainer, and the result of the examination was as follows.

For the examination, the distance between the pair of piece members both engaging with the respective wire members are rendered closer and each of said pair of piece members is grasped with a tool. Both of said piece members are then pulled in such a direction that they are away from each other (i.e. a direction the whole length of the eyeglass retainer gets longer) at a speed of 100 mm/min. by means of a tensile tester of the constant speed extension type, and the value of the generated tensile force when the piece members start to move against the wire members is measured. As a result, with sample A which is thought that it gives desirable frictional force, the piece members started to move against the wire members with tensile force of 22.9 N (Newton), and the same tensile force was measured during the movement. With sample B which is thought desirable as well, the piece members started to move with tensile force of 2.4 N, and the same tensile force was measured during the movement.

The same examinations were conducted for the other samples of which frictional force is thought desirable. As a result, it is proved with the eyeglass retainer of this invention that movement with proper frictional force of the piece members against the wire members can be obtained by applying the tensile force of 2.0 to 3.5 N, more preferably 2.2 to 3.0 N to between the wire member and the tube made of elastic resin. Note that, not only the outer and inner diameters of both members but also the coating material and its coating pattern onto the wire member are important for maintaining such tensile force.

As more specific values used for the samples provided to the examinations as described above, the outer diameter of the wire member made of stainless steel (material: SUS 304) is 1.00 to 1.01 mm and the outer diameter after coating with resin is 1.29 to 1.30 mm.

### EXAMPLE 2

Now, the other examples of the eyeglass retainer according to this invention will be explained below.

In Example 2 according to this invention, the elastic tube is so structured that it can be easily attached and detached against the wire member, and that the elastic tubes are made interchangeable with any of the other elastic tubes having various hole shapes which are prepared beforehand so that various types of eyeglasses can be attached by replacing the elastic tubes only.

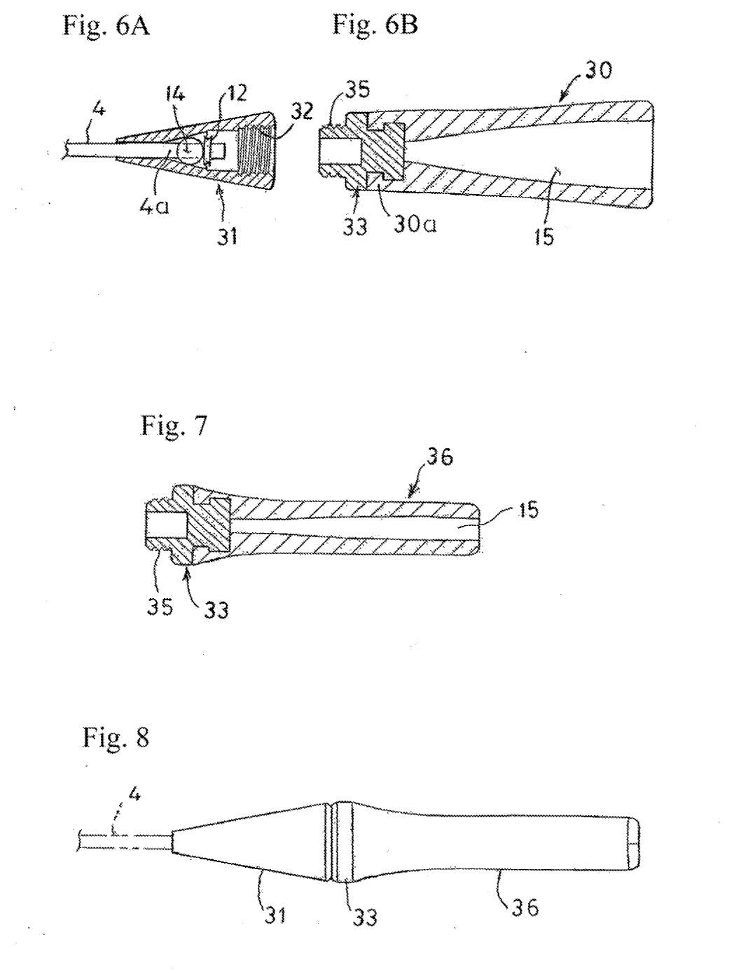

Referring to FIGS. 6A and 6B, the first hard resin member (the first hard member, material: ABS) 31 is connected to the basal portion 4a of the wire member 4 to be connected to the elastic tube 30 of Example 2 in the manner unable to remove therefrom. The first hard member 31 is a member of substantially hollow corn shape as a whole, and the tip portion of the first hard member 31 is made in large diameter and a screw groove 32 is formed on the inner surface of the groove. As to the elastic tube 30 shown in FIG. 6B, the second hard member (material: ABS) 33 is stuck to the end (tip end) 30a of the side opposite to the side where the temple of the eyeglasses is forcibly inserted by means of molding process. At the outer circumference of the tip end of the second hard member 33, a screw portion (male screw portion) 35 adapted to be engaged with the screw portion 32 formed on the inner surface of the first hard member 31 is provided.

The elastic tube 30 is connected to the wire member 4 by virtue of screwed connection of the first and second hard members 31, 33 and the elastic tube 30 is disconnected from the wire member 4 due to the manual release of said screwed connection. Following to the disconnection, the elastic tube 30 is interchangeable with an elastic tube of the other size that fits to the temple of the eyeglasses. By commonly using the second hard member 33, and by preparing several types of elastic tubes 36 each having the end hole 15 with different size and adapted to be forcibly inserted with the temple as shown in FIG. 7, the elastic tubes may be easily connected to the wire members by selecting elastic tubes that correspond to each of various eyeglass frames. Though it is so configured that the screw portion at the end outer circumference of the second hard member 33 is screwed into the screw portion on the inner surface of the first hard member 31 in the example described above, it may be configured inversely such that the male screw portion is provided to the outer circumference of the first hard member 31 and the other screw portion is provided to the inner surface of the second hard member so that both screw portions may be screwed in removable manner. FIG. 8 is a side view showing the state of the above-described screwed connection of the first hard member 31 and the second hard member 33 of the elastic tube 36, wherein the elastic tube 36 is easily removed from the wire member 4 by manually rotating the elastic tube 36 to the direction of releasing the screwed connection against the wire member 4.

The connection structure of the wire member 4 and the first hard member 31 as shown in FIG. 6A is basically the same as the connection structure of the elastic tube 2 and the wire member 4 of Example 1 as shown in FIG. 3. The round member 14 is placed to the basal portion of the wire member 4 in the hollow portion of the first hard member 31, and the stopper 12 that constrains the round member 14 is fixed to the end of the wire member 4 by means of caulking fixation.

What is claimed is:

1. An eyeglass retainer adapted to be fitted to the temple of eyeglasses and worn behind the wearer's head comprising:
a pair of elastic tubes, to those which the ends of temples are forcibly inserted, respectively,
a pair of wire members, the basal portions of those which are connected to the elastic tubes, respectively, and
a pair of piece members fixed to the tip ends of the wire members, respectively,
wherein one of the pair of wire members is slidably inserted through the piece member stuck to the tip end of the other wire member under intervention of given frictional force,
said other wire member is slidably inserted through the piece member stuck to the tip end of said one of the pair of wire members under intervention of given frictional force,
inside the each of the piece members, a tube made of elastic synthetic resin adapted to be slidably inserted with the wire member under intervention of given frictional force is embedded,
the wire members and the tubes made of elastic synthetic resin are configured such that tensile force to be generated when the pair of piece members sliding against the wire members are pulled to such direction that they are away from each other at a speed of 100 mm/min. reaches to a range of from 0.2 to 3.5 N (Newton), and
first hard member is connected to the basal portion of each wire member, and second hard member is stuck to the end of each elastic tube, screw portions for screw-connecting the first and second hard members are respectively formed to both types of hard members, and the elastic tubes adapted to be inserted with the wire members are interchangeable with the other by unscrewing the screw portions.

2. The eyeglass retainer of claim 1
wherein the wire member is a wire member made of stainless steel coated with resin and the tube made of elastic synthetic resin is a tube made of silicon rubber.
